(19) United States
(12) Patent Application Publication
(10) Pub. No.: US 2015/0229140 A1
(43) Pub. Date: Aug. 13, 2015

(54) APPARATUS AND METHOD FOR BALANCING BATTERY CELLS

(71) Applicant: Samsung SDI Co., Ltd., Yongin-si (KR)

(72) Inventor: Tae-Jin Kim, Yongin-si (KR)

(21) Appl. No.: 14/599,205

(22) Filed: Jan. 16, 2015

(30) Foreign Application Priority Data
Feb. 7, 2014 (KR) 10-2014-0014164

(51) Int. Cl. H02J 7/00

(52) U.S. Cl. CPC H02J 7/0014

(57) ABSTRACT

An apparatus and method for balancing battery cells are disclosed. In one aspect, the apparatus includes a plurality of discharge circuits and a controller. The discharge circuits are respectively connected to the battery cells in parallel. Each discharge circuit includes a switch electrically connected to the corresponding battery cell, and the switch is configured to reduce the amount of current flowing through the battery cell when the switch is turned on. The controller is configured to turn on the switch according to a predetermined duty ratio.

### RELATED APPLICATIONS

This application claims priority to and the benefit of Korean Patent Application No. 10-2014-0014164, filed on Feb. 7, 2014, in the Korean Intellectual Property Office, the entire contents of which are incorporated herein by reference in their entirety.

### BACKGROUND

1. Field

The described technology generally relates to an apparatus and a method for balancing battery cells.

2. Description of the Related Technology

As consumer electronics, communication and computer industries are continuing to grow, the usage of portable electronic devices and electric vehicles has recently increased. Rechargeable secondary batteries are frequently used as their power sources.

When a high-capacity power source is required, a secondary battery, which has a plurality of battery cells electrically connected in series, is used. Each battery cell can degrade as the battery cell is charged and discharged continuously. The degree of degradation can be different because not all battery cells are built uniformly. The variation of degradation affects charging/discharging times and amounts of the battery cells. A battery cell with more degradation has a charging/discharging time shorter than that of other battery cells with less degradation, and therefore, becomes fully charged or discharged faster than others. If such charging/discharging continues, the degradation of the battery cell worsens, which can eventually result in a fire or explosion.

### SUMMARY OF THE INVENTION

One inventive aspect is an apparatus and a method for balancing battery cells, which can perform battery cell balancing without using a plurality of resistors.

Another aspect is an apparatus for balancing battery cells, the apparatus including: a plurality of battery cells coupled in series; a discharge circuit configured to include a switch element coupled between both end portions of the battery cell, the discharge circuit forming a discharge path that bypasses the battery cell when the switch element is turned on; and a battery cell controller configured to output a switch control signal for controlling the turn-on of the switch element, wherein the battery cell controller outputs the switch control signal so that the switch element is turned on at a predetermined duty ratio.

Another aspect is a method for balancing battery cells, the method including: forming a discharge path that bypasses each battery cell by turning on a switch element coupled between both end portions of each of the plurality of battery cells coupled in series; and outputting a switch control signal for controlling the turn-on of the switch element, wherein the outputting of the switch control signal includes outputting the switch control signal so that the switch element is turned on at a predetermined duty ratio.

In the above aspect, the turn-on of the transistor of the discharge circuit is controlled, so that it is possible to control the charging current for charging the battery cell. Accordingly, when the voltage of any one battery cell is higher than that of each of the other battery cells, it is possible to lower the charging current for charging the battery cell. That is, it is possible to perform battery cell balancing.

Further, the discharge circuit does not include a plurality of resistors coupled between one end of the battery cell and the transistor. As a result, it is possible to prevent an increase in cost due to the plurality of resistors.

Further, the transistor is turned on at a predetermined duty ratio, so that it is possible to control the current flowing through the transistor of the discharge circuit to be no more than a predetermined value. The predetermined value can be a high current value to an extent where the transistor of the discharge circuit can be destroyed. As a result, it is possible to prevent the transistor from being destroyed even though the discharge circuit does not include a plurality of resistors coupled between the other end of the battery cell and the transistor.

Further, a fuse can be formed between the one end of the battery cell and the transistor.

Another aspect is an apparatus comprising a plurality of battery cells, a plurality of discharge circuits and a battery cell controller. The battery cells are connected in series, wherein each of the battery cells comprises two opposing sides. The discharge circuits are respectively connected to the battery cells in parallel, wherein each discharge circuit includes a switch electrically connected to the opposing ends of the respective battery cell, and wherein the discharge circuit including a discharge path is configured to bypass the battery cell when the switch is turned on. The battery cell controller is configured to output a switch control signal so as to turn on the switch according to a predetermined duty ratio.

In the above apparatus, the switch control signal comprises i) a gate-on voltage generated during a period in which the switch is turned on, and ii) a gate-off voltage generated during a period in which the switch is turned off. In the above apparatus, the switch comprises a transistor. In the above apparatus, each of the discharge circuits further includes a fuse electrically connected to one of the two ends of the corresponding battery cell and the transistor.

In the above apparatus, the battery cell controller is electrically connected to the two opposing ends of each battery cell and configured to i) sense a voltage of each battery cell, ii) calculate an average voltage of the battery cells, and iii) calculate a voltage difference between the voltage of each battery cell and the average voltage. In the above apparatus, the battery cell controller is further configured to generate i) the gate-on voltage when the voltage difference is substantially equal to or greater than a first threshold value, and ii) the gate-off voltage when the voltage difference is less than the first threshold value.

In the above apparatus, the battery cell controller is further configured to change the duty ratio based on the voltage difference. In the above apparatus, the battery cell controller is further configured to generate i) the gate-on voltage according to a first duty ratio when the voltage difference is substantially equal to or greater than the first threshold value, ii) the gate-on voltage according to a second duty ratio less than the first duty ratio when the voltage difference is less than the first threshold value and substantially equal to or greater than a second threshold value, and iii) the gate-off voltage when the voltage difference is less than the second threshold value.

In the above apparatus, the battery cell controller is further configured to control the duty ratio substantially proportional to the voltage difference.

Another aspect is a method for balancing a plurality of battery cells connected in series, the method comprising turning on a switch, electrically connected to two opposing ends of each battery cell so as to form a discharge path that bypasses each battery cell, and outputting a switch control signal for controlling the switch according to a predetermined ratio.

In the above method, the outputting includes generating i) a gate-on voltage during a period in which the switch is turned on, and ii) a gate-off voltage during a period in which the switch is turned off. In the above method, the outputting further includes sensing voltages of each battery cell, calculating the average voltage of the battery cells based on the sensed voltage, and calculating a voltage difference between the sensed voltage and the average voltage. In the above method, the switch is turned on when the voltage difference is substantially equal to or greater than a first threshold value, wherein the switch is turned off when the voltage difference is less than the first threshold value. In the above method, the outputting further includes changing the duty ratio based on the voltage difference.

In the above method, the switch is turned on according to a first duty ratio lower than the predetermined ratio when the voltage difference is less than the first threshold value and substantially equal to or greater than a second threshold voltage, and wherein the switched is turned off when the voltage difference is less than the second threshold value.

In the above method, the duty ratio is substantially proportional to the voltage difference.

Another aspect is an apparatus for balancing a plurality of battery cells connected in series, the apparatus comprising a plurality of discharge circuits and a controller. The discharge circuits are respectively connected to the battery cells in parallel, wherein each discharge circuit includes a switch electrically connected to the corresponding battery cell, and wherein the switch is configured to reduce the amount of current flowing through the battery cell when the switch is turned on. The controller is configured to turn on the switch according to a predetermined duty ratio.

In the above apparatus, the switch is configured to be turned on according to a switch control signal comprising i) a gate-on voltage generated during a period in which the switch is turned on, and ii) a gate-off voltage generated during a period in which the switch is turned off. In the above apparatus, the controller is electrically connected to opposing ends of each battery cell and configured to i) sense a voltage of each battery cell, ii) calculate an average voltage of the battery cells, and iii) calculate a voltage difference between the voltage of each battery cell and the average voltage. In the above apparatus, each of the discharge circuits further includes a fuse electrically connected to one end of the corresponding battery cell and the switch.

As a result, it is possible to prevent the transistor from being destroyed even though the discharge circuit does not include a plurality of resistors coupled between the one end of the battery cell and the transistor.

### BRIEF DESCRIPTION OF THE DRAWINGS

FIG. 1 is an exemplary diagram illustrating an apparatus for balancing battery cells according to an embodiment.

FIGS. 2A and 2B are exemplary diagrams illustrating charge current flowing in a battery cell and a discharge circuit.

FIG. 3 is a circuit diagram illustrating in detail a battery cell module of FIG. 1.

FIG. 4 is a flowchart illustrating a method for controlling battery cells in a battery cell controller according to a first embodiment.

FIG. 5 is a waveform diagram illustrating an example of a switch control signal supplied to a switch element of FIG. 2.

FIG. 6 is an exemplary diagram illustrating a duty ratio with respect to a voltage difference between a voltage of each battery cell and an average voltage according to the first embodiment.

FIG. 7 is a flowchart illustrating a method for controlling battery cells in the battery cell controller according to a second embodiment.

FIG. 8A is a waveform diagram illustrating an example of a switch control signal having a first duty ratio.

FIG. 8B is a waveform diagram illustrating an example of a switch control signal having a second duty ratio.

FIG. 9 is an exemplary diagram illustrating a duty ratio with respect to a voltage difference between a voltage of each battery cell and an average voltage according to the second embodiment.

FIG. 10 is an exemplary diagram illustrating a duty ratio with respect to a voltage difference between a voltage of each battery cell and an average voltage according to a third embodiment.

FIG. 11 is an exemplary diagram illustrating a duty ratio with respect to a voltage difference between a voltage of each battery cell and an average voltage according to a fourth embodiment.

### DETAILED DESCRIPTION OF THE PREFERRED EMBODIMENT

In order to prevent the problem of battery cells degrading at different rates, battery cell balancing is being widely developed. Battery cell balancing can include batteries cells electrically connected in series being charged while maintaining the voltage difference among the battery cells within a predetermined range. However, in such cell balancing, the discharge path of each battery cell is typically formed using a plurality of resistors, hence causing cost increases due to the plurality of resistors.

Hereinafter, certain exemplary embodiments according to the described technology will be described with reference to the accompanying drawings. Here, when a first element is described as being coupled to a second element, the first element can be not only directly coupled to the second element but can also be indirectly coupled to the second element via a third element. Further, some of the elements that are not essential to the complete understanding of the invention are omitted for clarity. Also, like reference numerals refer to like elements throughout. In this disclosure, the term “substantially” includes the meanings of completely, almost completely or to any significant degree under some applications and in accordance with those skilled in the art.

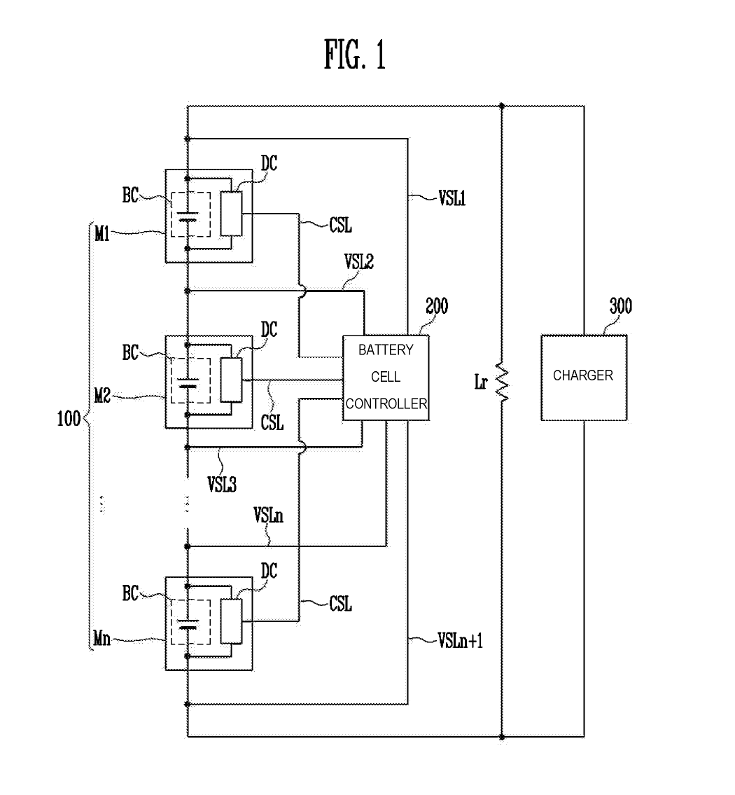

FIG. 1 is an exemplary diagram illustrating an apparatus for balancing battery cells according to an embodiment.

Referring to FIG. 1, the apparatus according to this embodiment includes a battery cell module unit or battery pack 100, a battery cell controller 200 and a charger 300.

The battery cell module unit 100 includes a plurality of battery cell modules M1, M2, . . . , Mn (n is a positive integer of 2 or more). The battery cell modules M1, M2, . . . , Mn, as shown in FIG. 1, are connected in series, and thus a plurality of battery cells BC are also connected in series.

Each battery cell module, as shown in FIG. 1, has the battery cell BC and a discharge circuit DC. The discharge circuit DC can be electrically connected to both end portions of the battery cell BC and a control signal line CSL. The discharge circuit DC can receive a switch control signal SCS (not shown) transmitted through the control signal line CSL. The discharge circuit DC can form a discharge path of charging current Ic output from the charger 300 according to the switch control signal SCS. The discharge path can be a current path that substantially bypasses or reduces the battery cell BC.

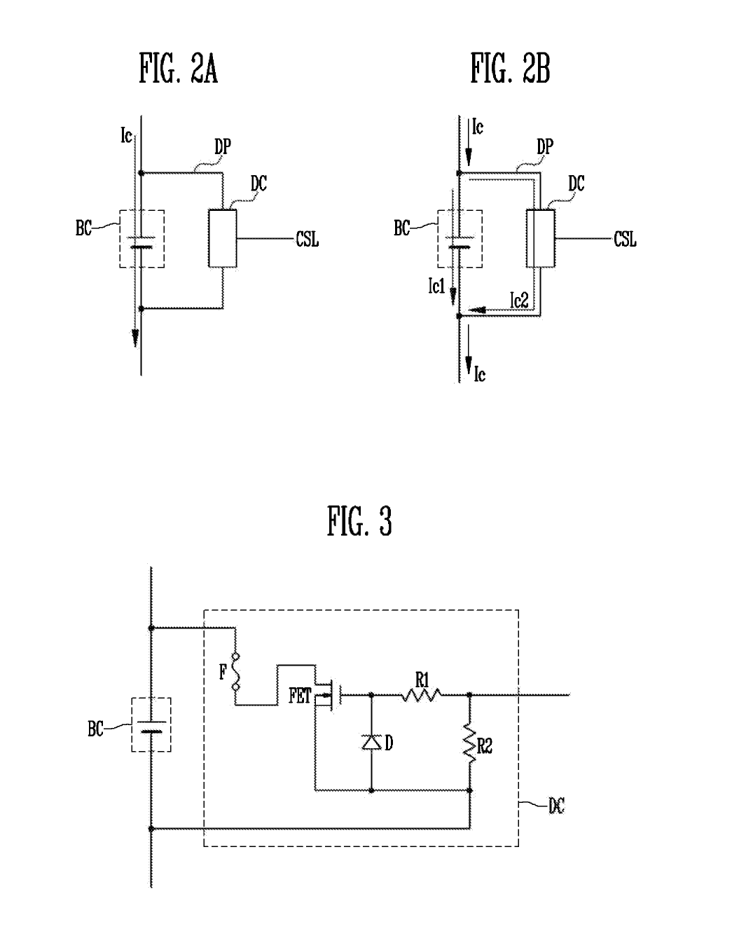

In some embodiments, when the switch control signal SCS having a first logic level voltage is output from the battery cell controller 200, the discharge circuit DC does not form the discharge path. In this case, as shown in FIG. 2A, the charging current Ic output from the charger 300 is supplied to the battery cell BC. In some embodiments, when the switch control signal SCS having a second logic level voltage is output from the battery cell controller 200, the discharge circuit DC forms the discharge current. In this case, as shown in FIG. 2B, a first charging current Ic1 is output to the battery cell BC, and a second charging current Ic2 flows along the discharge path DP of the discharge circuit DC. Here, the sum of the first and second charging currents Ic1 and Ic2 is the charging current Ic. The discharge circuit DC will be described in detail later in reference to FIG. 3.

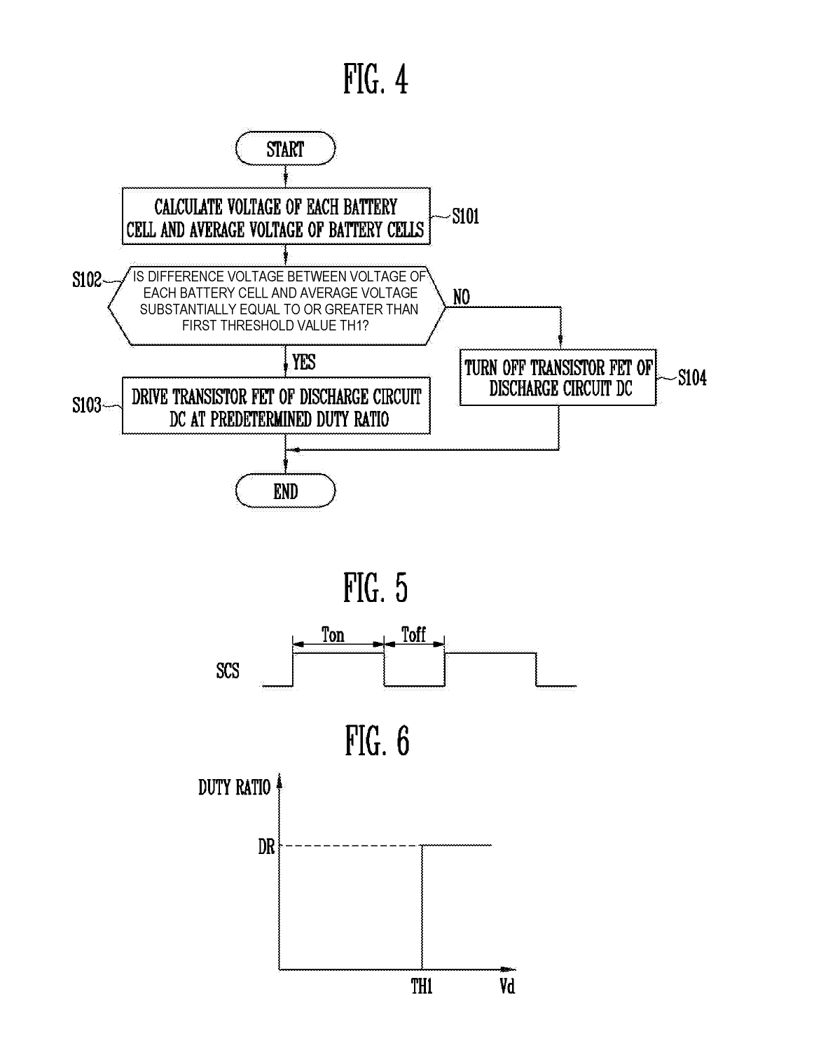

In some embodiments, voltage sensing lines VSL1, VSL2, VSL3, . . . , VSLn+1 are electrically connected to both end portions of the respective battery cell modules M1, M2, . . . , Mn and the battery cell controller 200. The battery cell controller 200 can calculate a voltage of each battery cell BC, based on voltages sensed from the voltage sensing lines VSL1, VSL2, VSL3, . . . , VSLn+1. Therefore, the battery cell controller 200 can calculate the average voltage of the battery cells BC. In addition, the battery cell controller 200 can calculate a voltage difference Vd between the voltage of the battery cell BC and the average voltage. In some embodiments, the battery cell controller 200 generates the switch control signal SCS according to the difference, and outputs the generated switch control signal SCS to the discharge circuit DC of each battery cell module. The battery cell controller 200 will be described in detail later in reference to FIG. 4.

The charger 300 can supply the charging current Ic to the battery cell module unit 100. A predetermined load Lr can be formed in parallel to the charger 300.

FIG. 3 is a circuit diagram illustrating in detail the battery cell module of FIG. 1.

Referring to FIG. 3, the battery cell module includes a battery cell BC and the discharge circuit DC.

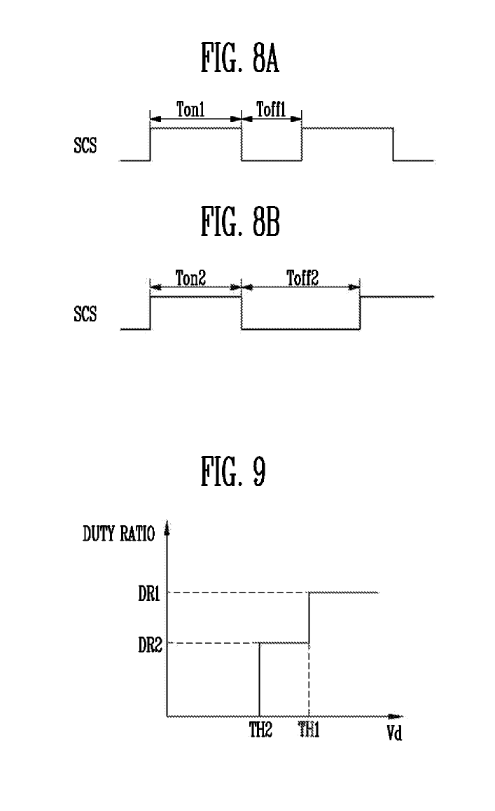

The discharge circuit DC can include a switch element and a fuse F. The switch element can include a transistor as shown in FIG. 3. The transistor can be a field effect transistor (FET). Although it has been illustrated in FIG. 3 that the transistor is an N-type FET, the described technology is not limited thereto. That is, the transistor can be a P-type FET. When the P-type FET is used, waveforms shown in FIGS. 5, 8A and 8B changes corresponding to the P-type FET.

Referring to FIG. 3, the transistor FET is turned on by the switch control signal SCS to form the discharge path DP. In some embodiments, when the transistor FET is turned on, the first charging current Ic1 flows through the battery cell BC, and the second charging current Ic2 flows through the transistor FET. In some embodiments, when the transistor FET is turned off, the charging current Ic flows through only the battery cell BC.

A gate electrode of the transistor FET is electrically connected to the control signal line CSL. A first electrode (e.g., source or drain) of the transistor FET can be electrically connected to one end of the battery cell BC, and a second electrode (e.g., drain or source) of the transistor FET can be electrically connected to the fuse F.

The fuse F can be electrically connected to the other end of the battery cell BC and to the second electrode of the transistor FET. The fuse F can be used to prevent the transistor FET from being destroyed when the second charging current Ic2 flowing through the transistor FET is increased as the turn-on period of the transistor FET is lengthened.

The discharge circuit DC can further include a diode D and first and second resistors R1 and R2. The diode D can be electrically connected to the gate electrode and to the first electrode of the transistor FET. In some embodiments, the diode D can protect the transistor FET from overvoltage. The first resistor R1 can be electrically connected to the other end of the battery cell BC and the control signal line CSL, and the second resistor R2 can be electrically connected to the control signal line CSL.

As a result, in some embodiments, the turn-on of the transistor FET is controlled so that it is possible to control the charging current for charging the battery cell BC. Accordingly, when the voltage of any one battery cell BC is higher than that of each of the other battery cells BC, it is possible to lower the charging current, thereby perform battery cell balancing.

In some embodiments, the discharge circuit DC does not include a plurality of resistors electrically connected to the other end of the battery cell BC and the transistor FET. Therefore, it is possible to prevent an increase in cost due to the resistors.

In some embodiments, the fuse F is formed between the other end of the battery cell BC and the transistor FET. Therefore, it is possible to prevent the transistor FET from being destroyed even though the discharge circuit DC does not include the resistors.

FIG. 4 is a flowchart illustrating a method for controlling battery cells BC in the battery cell controller 200 according to a first embodiment. Hereinafter, the method for controlling battery cells in the battery cell controller 200 according to the first embodiment will be described in detail in reference to FIGS. 1, 3 and 4.

In some embodiments, the FIG. 4 procedure is implemented in a conventional programming language, such as C or C++ or another suitable programming language. The program can be stored on a computer accessible storage medium of the battery cell controller 200, for example, a memory (not shown) of the battery cell controller 200. In certain embodiments, the storage medium includes a random access memory (RAM), hard disks, floppy disks, digital video devices, compact discs, video discs, and/or other optical storage mediums, etc. The program can be stored in the processor. The processor can have a configuration based on, for example, i) an advanced RISC machine (ARM) microcontroller and ii) Intel Corporation's microprocessors (e.g., the Pentium family microprocessors). In certain embodiments, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 8/7/Vista/2000/9x/ME/XP, Macintosh OS, OS X, OS/2, Android, iOS and the like. In another embodiment, at least part of the procedure can be implemented with embedded software. Depending on the embodiment, additional states can be added, others removed, or the order of the states changed in FIG. 4. The above description also applies for the FIG. 7 procedure described below.

In step S101, the battery cell controller 200 can calculate the voltage of each battery cell BC, based on the voltages sensed from the voltage sensing lines VSL1, VSL2, VSL3, . . . , VSLn+1. The battery cell controller 200 can calculate the average voltage of the battery cells BC.

In step S102, the battery cell controller 200 can calculate the voltage difference Vd between the voltage of each battery cell BC and the average voltage. The battery cell controller 200 decides whether the voltage difference Vd is substantially equal to or greater than a first threshold value TH1.

In step S103, when the voltage difference Vd is substantially equal to or greater than the first threshold value TH1, the battery cell controller 200 outputs the switch control signal SCS so that the transistor FET is turned on according to a predetermined duty ratio DR. The duty ratio DR can be defined as shown in Equation 1.

$$DR = \frac{{T}_{totalon}}{{T}_{totalon} + {T}_{totaloff}} \qquad Equation 1$$

In Equation 1, Tₜₒₜₐₗₒₙ denotes an actual turn-on period, and T_{totaloff} denotes an actual turn-off period.

The actual turn-on period (Tₜₒₜₐₗₒₙ) can be defined as shown in Equation 2.

Tₜₒₜₐₗₒₙ=Tₒₙ−Tdₒₙ+Td_{off} Equation 2

In Equation 2, Tₒₙ denotes a turn-on period of the transistor FET, Tdₒₙ denotes a turn-on delay period of the transistor FET, and Td_{off} denotes a turn-off delay period of the transistor FET.

The actual turn-off period (T_{totaloff}) of the transistor FET can be defined shown in Equation 3.

T_{totaloff}=T_{off}−Td_{off}+Tdₒₙ Equation 3

In Equation 3, T_{off} denotes a turn-off period of the transistor FET, Td_{off} denotes a turn-off delay period of the transistor FET, and Tdₒₙ denotes a turn-on delay period of the transistor FET.

When the discharge circuit DC forms the discharge path DP, the second charging current Ic2 can be defined as shown in Equation 4.

$$Ic 2 = \frac{Vc \times DR}{{R}_{FET}} \qquad Equation 4$$

In Equation 4, Ic2 denotes a second charging current, Vc denotes a voltage of the battery cell BC, DR denotes a duty ratio, and R_{FET} denotes a channel resistance of the transistor FET.

In Equation 4, the second charging current Ic2 proportional to the duty ratio DR, and hence can be controlled by adjusting the duty ratio DR. The turn-on delay time (Tdₒₙ) and the turn-off delay period (Td_{off}) can be changed depending on characteristics of the transistor FET. Accordingly, the duty ratio DR can be adjusted by controlling the turn-on delay time (Tdₒₙ) and the turn-off delay period (Td_{off}).

As a result of the operation of FIG. 4, the battery cell controller 200 can generate a gate-off voltage (Voff) and transmit it as the switch control signal SCS during the turn-off period (T_{off}). Also, the battery cell controller 200 can generate a gate-on voltage (Von) as the switch control signal SCS during the turn-on period (Tₒₙ). The gate-off voltage (Voff) represents a voltage at which the transistor FET is turned off, and the gate-on voltage (Von) represents a voltage at which the transistor FET is turned on. Thus, the battery cell controller 200 can control the transistor FET to be turned on according to a predetermined duty ratio DR. Accordingly, the discharge path DP can be formed in the discharge circuit DC.

In step S104, when the difference between the voltage of the battery cell BC and the average voltage is smaller than the first threshold value TH1, the battery cell controller 200 outputs the switch control signal SCS having the gate-off voltage (Voff). Accordingly, the transistor FET of the discharge circuit DC is turned off, and therefore, the discharge circuit DC does not form the discharge path.

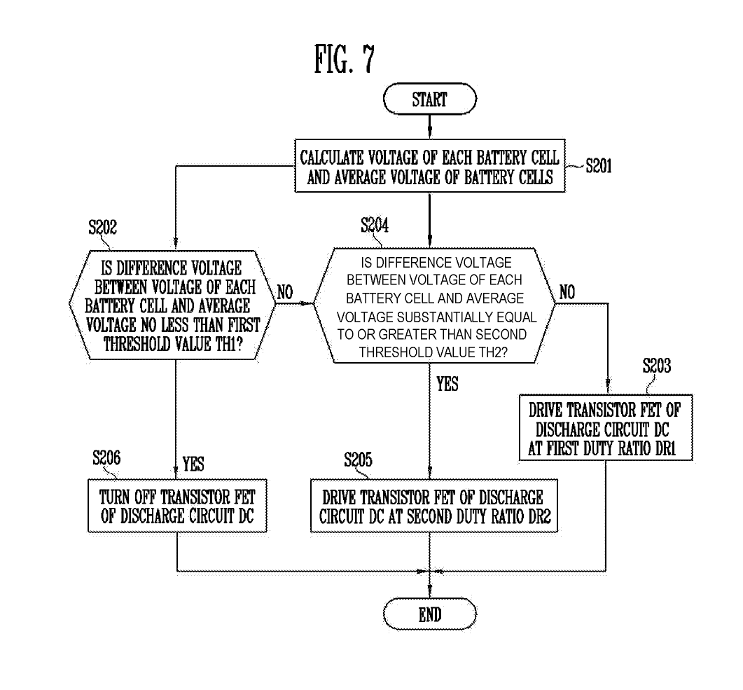

As described above in reference to the first embodiment, when the voltage difference Vd is substantially equal to the first threshold value TH1 as shown in FIG. 6A, the battery cell controller 200 controls the transistor FET according to a predetermined duty ratio DR. As a result, in the first embodiment, the battery cell controller 200 can form the discharge path DP to lower the charging current, thereby performing the battery cell balancing.

In the first embodiment, the battery cell controller 200 turns on the transistor FET according to a predetermined duty ratio DR, so that it is possible to control the second charging current Ic2 to be no more than a predetermined value. The predetermined value can represent a voltage in which the transistor FET can be destroyed. As a result, in the first embodiment, it is possible to prevent the transistor FET from being destroyed even through the discharge circuit DC does not include a plurality of resistors electrically connected to the other end of the battery cell BC and the transistor FET.

FIG. 7 is a flowchart illustrating a method for controlling battery cells in the battery cell controller 200 according to a second embodiment. Hereinafter, the method for controlling battery cells in the battery cell controller 200 according to the second embodiment will be described in detail in reference to FIGS. 1, 3 and 7.

Steps S201 and S202 according to the second embodiment are substantially identical to steps S101 and S102 according to the first embodiment, and therefore, their detailed descriptions will be omitted.

In step S203, when the voltage difference Vd is substantially equal to or greater than the first threshold value TH1, the battery cell controller 200 outputs the switch control signal SCS so that the transistor FET is turned according to a first duty ratio DR1. As shown in FIG. 8A, the battery cell controller 200 generates the gate-off voltage (Voff) as the switch control signal SCS during a first turn-off period (T_{off}1) of the transistor FET. Also, the battery cell controller 200 can generate the gate-on voltage (Von) as the switch control signal SCS during a first turn-on period (Tₒₙ1) of the transistor FET. Thus, the battery cell controller 20 can control the transistor FET to be turned on according to the first duty ratio DR1. Accordingly, the discharge path DP can be formed in the discharge circuit DC.

In step S204, when the voltage difference Vd is less than the first threshold value TH1, the battery cell controller 200 decides whether the voltage difference Vd between the voltage of the battery cell BC and the average voltage is substantially equal to or greater than a second threshold value TH2.

In step S205, when the voltage difference Vd is less than the first threshold value TH1 and substantially equal to or greater than the second threshold value TH2, the battery cell controller 200 outputs the switch control signal SCS so that the transistor FET of the discharge circuit DC is turned on according to a second duty ratio DR2 less than the first duty ratio DR1.

As shown in FIG. 8B, the battery cell controller 200 generates the gate-off voltage (Voff) the switch control signal SCS during a second turn-off period (T_{off}2) of the transistor FET, and generates the gate-on voltage (Von) the switch control signal SCS during a second turn-on period (Tₒₙ2) of the transistor FET. Thus, the battery cell controller 200 can control the transistor FET to be turned on according to the second duty ratio DR2. Accordingly, the discharge path DP can be formed in the discharge circuit DC.

As shown in FIG. 8B, the second turn-off period (T_{off}2) is longer than the first turn-off period (T_{off}1). In addition, the second turn-on period (T_{onf}2) is longer than the first turn-on period (Tₒₙ1).

In step S206, when the voltage difference Vd is less than the second threshold value TH2, the battery cell controller 200 does not output the switch control signal SCS. Accordingly, in some embodiments, the transistor FET is turned off, and therefore, the discharge circuit DC does not form the discharge path DP.

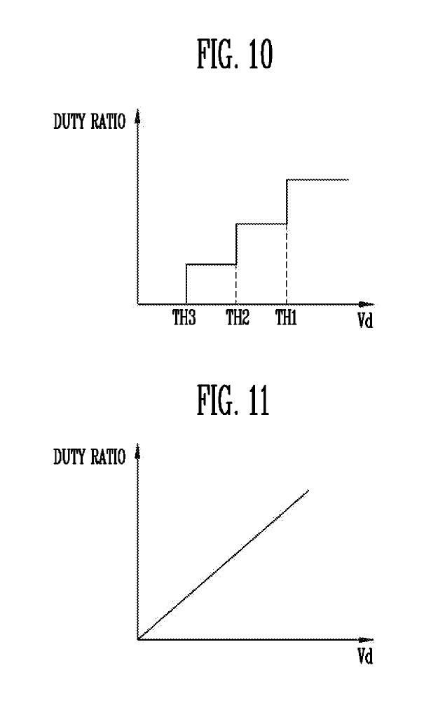

As described above, in the second embodiment, when the voltage difference Vd is substantially equal to or greater than the first threshold value TH1 as shown in FIG. 9, the battery cell controller 200 controls the transistor FET according to the first duty ratio DR1. In the second embodiment, when the voltage difference Vd is less than the first threshold value TH1 and substantially equal to or greater than the second threshold value TH2 as shown in FIG. 9, the battery cell controller 200 controls the transistor FET according to the second duty ratio DR2. As a result, in the second embodiment, the battery cell controller 200 forms the discharge path DP to lower the charging current, thereby implementing the battery cell balancing.

In the second embodiment, the battery cell controller 200 controls the duty ratio through two steps according to the voltage difference Vd. Accordingly, in the second embodiment, the battery cell controller 200 controls the second charging current to have two levels. As a result, in the second embodiment, it is possible to perform battery cell balancing which substantially maintains the difference in voltage among the battery cells to be less than that of the first embodiment.

In the second embodiment, the battery cell controller 200 turns on the transistor FET according to a predetermined duty ratio so that it is possible to control the second charging current Ic2 to be less than or substantially equal to a predetermined value. The predetermined value can represent a voltage in which the transistor FET can be destroyed. As a result, in the second embodiment, it is possible to prevent the transistor FET from being destroyed even through the discharge circuit does not include a plurality of resistors electrically connected to the other end of the battery cell BC and the transistor FET.

FIG. 10 is an exemplary diagram illustrating a duty ratio with respect to a voltage difference Vd according to a third embodiment.

Referring to FIG. 10, in the third embodiment, the battery cell controller 200 controls the duty ratio DR through greater than two steps according to the voltage difference Vd. In some embodiments, the battery cell controller 200 includes a look-up table that stores the duty ratio DR according to the voltage difference Vd.

Accordingly, in the third embodiment, the battery cell controller 200 controls the second charging current to have more levels greater than that of the second embodiment. As a result, in the third embodiment, it is possible to perform battery cell balancing which maintains the difference in voltage among the battery cells connected in series to be less than that of the second embodiment.

FIG. 11 is an exemplary diagram illustrating a duty ratio with respect to a voltage difference Vd according to a fourth embodiment.

Referring to FIG. 11, in the fourth embodiment, the battery cell controller 200 controls the duty ratio DR to be proportional to the voltage difference Vd. In some embodiments, the battery cell controller 200 includes a look-up table configured to store the duty ratio DR according to the voltage difference Vd.

Accordingly, in the fourth embodiment, the battery cell controller 200 controls the second charging current to have more levels than that of the second embodiment. As a result, in the fourth embodiment, it is possible to perform battery cell balancing which maintains the difference in voltage among the battery cells electrically connected in series to be less than that of the second embodiment.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment can be used singly or in combination with features, characteristics, and/or elements described in connection with other embodiments unless otherwise specifically indicated. Accordingly, it will be understood by those of skill in the art that various changes in form and details can be made without departing from the spirit and scope of the inventive technology as set forth in the following claims.

What is claimed is:

1. An apparatus for balancing battery cells, the apparatus comprising:
a plurality of battery cells connected in series, wherein each of the battery cells comprises two opposing sides;
a plurality of discharge circuits respectively connected to the battery cells in parallel, wherein each discharge circuit includes a switch electrically connected to the opposing ends of the respective battery cell, and wherein the discharge circuit including a discharge path is configured to bypass the battery cell when the switch is turned on; and
a battery cell controller configured to output a switch control signal so as to turn on the switch according to a predetermined duty ratio.

2. The apparatus of claim 1, wherein the switch control signal comprises i) a gate-on voltage generated during a period in which the switch is turned on, and ii) a gate-off voltage generated during a period in which the switch is turned off.

3. The apparatus of claim 2, wherein the switch comprises a transistor.

4. The apparatus of claim 3, wherein each of the discharge circuits further includes a fuse electrically connected to one of the two ends of the corresponding battery cell and the transistor.

5. The apparatus of claim 2, wherein the battery cell controller is electrically connected to the two opposing ends of each battery cell and configured to i) sense a voltage of each battery cell, ii) calculate an average voltage of the battery cells, and iii) calculate a voltage difference between the voltage of each battery cell and the average voltage.

6. The apparatus of claim 5, wherein the battery cell controller is further configured to generate i) the gate-on voltage when the voltage difference is substantially equal to or greater than a first threshold value, and ii) the gate-off voltage when the voltage difference is less than the first threshold value.

7. The apparatus of claim 5, wherein the battery cell controller is further configured to change the duty ratio based on the voltage difference.

8. The apparatus of claim 7, wherein the battery cell controller is further configured to generate i) the gate-on voltage according to a first duty ratio when the voltage difference is substantially equal to or greater than the first threshold value, ii) the gate-on voltage according to a second duty ratio less than the first duty ratio when the voltage difference is less than the first threshold value and substantially equal to or greater than a second threshold value, and iii) the gate-off voltage when the voltage difference is less than the second threshold value.

9. The apparatus of claim 7, wherein the battery cell controller is further configured to control the duty ratio substantially proportional to the voltage difference.

10. A method for balancing a plurality of battery cells connected in series, the method comprising:
turning on a switch, electrically connected to two opposing ends of each battery cell so as to form a discharge path that bypasses each battery cell; and
outputting a switch control signal for controlling the switch according to a predetermined ratio.

11. The method of claim 10, wherein the outputting includes generating i) a gate-on voltage during a period in which the switch is turned on, and ii) a gate-off voltage during a period in which the switch is turned off.

12. The method of claim 11, wherein the outputting further includes:
sensing voltages of each battery cell;
calculating the average voltage of the battery cells based on the sensed voltage; and
calculating a voltage difference between the sensed voltage and the average voltage.

13. The method of claim 12, wherein the switch is turned on when the voltage difference is substantially equal to or greater than a first threshold value, and wherein the switch is turned off when the voltage difference is less than the first threshold value.

14. The method of claim 13, wherein the outputting further includes changing the duty ratio based on the voltage difference.

15. The method of claim 14, wherein the switch is turned on according to a first duty ratio lower than the predetermined ratio when the voltage difference is less than the first threshold value and substantially equal to or greater than a second threshold voltage, and wherein the switched is turned off when the voltage difference is less than the second threshold value.

16. The method of claim 13, wherein the duty ratio is substantially proportional to the voltage difference.

17. An apparatus for balancing a plurality of battery cells connected in series, the apparatus comprising:
a plurality of discharge circuits respectively connected to the battery cells in parallel, wherein each discharge circuit includes a switch electrically connected to the corresponding battery cell, and wherein the switch is configured to reduce the amount of current flowing through the battery cell when the switch is turned on; and
a controller configured to turn on the switch according to a predetermined duty ratio.

18. The apparatus of claim 17, wherein the switch is configured to be turned on according to a switch control signal comprising i) a gate-on voltage generated during a period in which the switch is turned on, and ii) a gate-off voltage generated during a period in which the switch is turned off.

19. The apparatus of claim 18, wherein the controller is electrically connected to opposing ends of each battery cell and configured to i) sense a voltage of each battery cell, ii) calculate an average voltage of the battery cells, and iii) calculate a voltage difference between the voltage of each battery cell and the average voltage.

20. The apparatus of claim 19, wherein each of the discharge circuits further includes a fuse electrically connected to one end of the corresponding battery cell and the switch.
